(19) United States
(12) Patent Application Publication
(10) Pub. No.: US 2026/0335935 A1
(43) Pub. Date: Oct. 29, 2026

(54) SORTER SYSTEM AND METHOD FOR SORTING

(71) Applicant: BEUMER GROUP GMBH & CO. KG, Beckum (DE)

(72) Inventors: Jorgen STAUN, Hinnerup (DK); Brian JONES, Hordle, Hampshire (GB); Stephen AUTHERS, Oxon, Oxfordshire (GB)

(21) Appl. No.: 19/117,664

(22) PCT Filed: Sep. 8, 2023
(86) PCT No.: PCT/EP2023/074775

§ 371 Date: Apr. 2, 2025

(30) Foreign Application Priority Data
Oct. 14, 2022 (EP) 22201688.3

(51) Int. Cl. B07C 3/08; B07C 5/36; B65G 47/69

(52) U.S. Cl. CPC B07C 3/08; B07C 5/36; B65G 47/69

(57) ABSTRACT

A sorter system for sorting objects, particularly parcels or mail items, the sorter system having a first sorter with a multiplicity of first load handling means for objects to be conveyed or sorted, the sorter system having a pouch system with a multiplicity of second load handling means for objects to be conveyed and/or stored or buffered, the sorter system having a first transfer station which is configured to transfer objects from the first load handling means of the first sorter to the second load handling means of the pouch system, wherein the first sorter is or comprises a lying sorter, preferably a cross-belt sorter or a tilt-tray sorter, and the pouch system is or comprises a pouch conveyor, the second load handling means being or comprising pouches, wherein the pouch system has a pouch storage for storing pouches, such that objects held by pouches are storable in the pouch storage. Another aspect of the invention relates to a method for sorting.

### CROSS-REFERENCE TO RELATED APPLICATIONS

This application is a U.S. National Phase Application under 35 U.S.C. 371 of International Application No. PCT/EP2023/074775, filed on Sep. 8, 2023, which claims priority to European Patent Application No. 22201688.3, filed on Oct. 14, 2022. The entire disclosures of the above applications are incorporated herein by reference.

### BACKGROUND

This section provides background information related to the present disclosure which is not necessarily prior art.

### Technical Field

The invention relates to a sorter system for sorting objects, particularly parcels or mail items. Such sorter systems are used in parcel centres, for example, where parcels are sorted for delivery. The sorter system usually has a parcel sorter, in general a lying sorter, for sorting the objects. A sorter system having a lying sorter and a pouch sorter is e.g. known from DE 10 2018 219 583 A1. Further, U.S. Pat. No. 11,390,463 B1 discloses a sorter system having a lying sorter with one or more shuttles, a pouch sorter, and a first transfer station, which is configured to transfer objects from the lying sorter to one or more flexible containers of the pouch system.

### Discussion

Parcel centres such as distribution accept and handle parcels, packages and other items of goods, generally shipments, within certain dimensions and weights and distribute or forward them. In contrast to department store shipping centres, such distribution centres are usually not designed to process orders, but rather to distribute the delivered parcels and other shipments as completely as possible within a defined time window. Generally, shipments arrive at the parcel distribution centre at different times and by different means of transport. The shipments are not necessarily separated according to size. Unloading of the shipments and feeding them to the sorter system can be automatic, semi-automatic semi-automatic or manual.

The lying sorter of the sorter system can be of the closed loop type (loop sorters) or of the line type (line sorters). For both types, the number of load handling means which transport or convey the shipments to the end points is relatively small in relation to the distributed number of pieces of shipments per hour, typically the ratio being less than 1:10. For example, a 500-meter parcel sorter may have 500 load handling means, with a distribution capacity of 9,000 items per hour. This is due in particular to the comparatively high cost share of the load handling means of the lying sorter. Thus, lying sorters are not particularly well suited for storing objects, such as shipments, parcels or the like.

If it is discovered during sorting that customs duty has not yet been paid and must therefore be paid in arrears, the parcel sorter must store the parcel for a specific time interval, usually up to a week, until outstanding fees and duties have been paid. Additionally, there is a growing number of services where the customer can specify when he wants to receive the parcel. Here, too, the parcels have to be stored temporarily.

Currently, these parcels are sorted out in special end points and usually stored temporarily in roller containers. This storing is cumbersome and inconvenient, since the parcels are piled upon each other without any ordering, making it difficult and time consuming to identify and retrieve a specific parcel from the pile.

In addition to the known storage in roller containers, where the problem usually is that it is not known exactly where which parcel is (as in case when custom duties have been paid and thus the stored parcel is to be forwarded) as mentioned above, there are also automatic high-bay warehouses that may be used for storage. These automatic high-bay warehouses are expensive and require intensive maintenance.

### SUMMARY

This section provides a general summary of the disclosure and is not a comprehensive disclosure of its full scope or all of its features.

It is therefore one aspect of the present invention to provide a sorting system and a method for sorting which overcome these drawbacks.

The invention provides a sorter system with a pouch system having a pouch storage, wherein objects to be buffered or stored can be transferred from the first sorter (i.e. the lying sorter) to the pouch system. Thus, the pouch buffer can be used to store objects, such as e.g. parcels for which customs duty has not been paid. Such pouch systems are relatively easy and cheap to design and maintain. Furthermore, it is straightforward to extend the storing capacity of the pouch storage. Additionally, the pouch system and/or the pouch storage can discharge a specific pouch stored in the pouch storage, so that a specific stored object can be quickly and easily retrieved.

A first aspect of the invention relates to a sorter system for sorting objects, the sorter system having a first sorter with a multiplicity of first load handling means for objects to be conveyed or sorted, the sorter system having a pouch system with a multiplicity of second load handling means for objects to be conveyed and/or sorted or buffered, the sorter system having a first transfer station which is configured to transfer objects from the first load handling means of the first sorter to the second load handling means of the pouch system, wherein the first sorter is or comprises a lying sorter, and the pouch system is or comprises a pouch conveyor, the second load handling means being or comprising pouches, wherein the pouch system has a pouch storage for storing pouches, such that objects held by pouches are storable in the pouch storage.

Thus, an object, such as e.g. a parcel for which duties have not been paid, fed to the first sorter can be transferred via the first transfer station to the pouch system and stored in the pouch storage. In particular, the object may be transferred from a first handling means with the first transfer station to a second handling means, in particular the pouch, and the pouch containing the object may be stored in the pouch storage. Then, the object can be easily retrieved (e.g. when the duty has been paid), i.e. the pouch containing the object can be conveyed to the second transfer station, where the object can be transferred to a first handling means and subsequently discharged. In other words, a specific object (or pouch) stored in the pouch storage can be easily identified and retrieved. In particular, the sorter system, pouch system and/or the pouch storage can be configured to identify and/or discharge, or transfer to the first sorter, any given or specified pouch in the pouch system and/or the pouch storage. In some embodiments, the objects may have an identifies, which may be unique. For instance, the identifier can comprise one or more of alphanumeric code, QR-Code, Bar-Code, and/or can comprise or be stored on an RFID-Chip. In some embodiments, the identifier may be arranged on a surface or the object. The identifier can be scanned or detected, such that a specific parcel can be identified. The sorter system can have one or more corresponding detectors or sensors, such as a camera, a scanner, or a reader. Thereby, the position of one, more than one or all objects in the sorter system can be known or determined. The identifier can comprise status data of the object.

The objects can be or comprise parcels, mail items, shipments, packages or the like. However, the invention is not restricted to such objects.

The lying sorter can be or comprise a cross-belt sorter or a tilt-tray sorter. For instance, the first load handling means can be or comprise carriages having one or more cross-belts, and/or one or more tilt-trays.

The sorter system can comprise a second sorter and/or second pouch system. The second sorter can be a pouch sorter. In some embodiments, the second sorter and/or second pouch system can comprise a pouch conveyor. The second sorter and/or second pouch system may have one, several or all features and/or advantages of the first sorter or the pouch system, respectively. In some embodiments, the sorter system can have a third transfer station which can be configured to transfer objects from the first sorter to the second sorter and/or second pouch system. In some embodiments, the sorter system can have a fourth transfer station which can be configured to transfer objects from the second sorter and/or the second pouch system to the first sorter. In some embodiments, the second sorter and/or second pouch system may provide additional storage for storing objects. Additionally or alternatively, the second sorter and/or second pouch system may be configured to store specific or specified objects. In some embodiments, only specific or specified, e.g. pre-determined, objects may be stored in the second sorter and/or second pouch system.

It may be provided that an object may be stored in a first pouch system or a second pouch system based on a feature or whether the object fulfills a criteria. The pouch system may be the first pouch system. In some embodiments, the sorter system can have more than two pouch systems, and an object may be stored in a specific or specified pouch system or a second pouch system based on a criteria. In some embodiments, the criteria may comprise a e.g. a delivery date. For instance, a first pouch system may store objects, for which a delayed delivery with a first delivery date has been requested. The second pouch system may store objects, for which a delayed delivery with a second delivery date has been requested. The second delivery date may be earlier or later than the first delivery date. First and second delivery date may differ by one or more days. In some embodiments, the criteria may comprise one or more of delivery date, delivery destination, sender of the object, addressee of the object, identity and/or address of sender and/or addressee, customs data, or content, and/or paid duty.

The sorter system can have a second pouch system, wherein the sorter system can be configured to transfer objects having a feature and/or fulfilling a criteria to the pouch system, and the sorter system can be configured to transfer objects having a different feature and/or fulfilling a different criteria to the second pouch system. The feature and/or different feature can comprises one or more of delivery date, delivery destination, sender of the object, addressee of the object, identity and/or address of sender and/or addressee, customs data, or content. Fulfilling the criteria and/or fulfilling the different criteria can comprise the object matching one or more of delivery date, delivery destination, sender of the object, addressee of the object, identity and/or address of sender and/or addressee, customs data, or content. The sorter system can be configured to check and/or determine whether an object has a feature of fulfills a criteria and can then transfer the object accordingly. For instance, an object may have a feature “delivery date” which can be in date-format such as e.g. “yyyy-mm-dd” or the like. If e.g. the date-format matches a determined or specific date-format, the object may fulfil the criteria or have the feature. Two objects having different features may comprise them having the same kind of feature or criteria, but different values of said feature or criteria. For instance, a first object may have the feature “duty paid” with value “false” and a second object may have the feature “duty paid” with value “true”, such that the first object may fulfill the criteria whereas the second may not (or vice versa). In that example, the criteria may be “duty paid”. Other features or criteria may be checked, combined or chosen. Objects may be transferred to the first pouch system or the second pouch system based on a combination of criteria and/or features. If the sorter system has more than two pouch systems, the objects may be transferred or distributed to the more than two pouch systems accordingly.

The first pouch system may be configured to store or buffer objects. The second pouch system may be configured to store of buffer objects. The second pouch system and or additional pouch systems may have one, more or all features or advantages of the pouch system.

The sorter system can have a second transfer station which can be configured to transfer objects from the second load handling means of the pouch system to the first load handling means of the pouch system.

The sorter system can have a control unit which can be configured to determine whether an object conveyed by a first load handling means of the first sorter is to be transferred, with the first transfer station, to a second load handling means of the pouch system or to be discharged from the first sorter. In some embodiments, the control unit can determine whether the object is to be stored by checking and/or comparing status data of the object. Status data can comprise e.g. delivery date, delivery destination, sander of the object, addressee of the object, customs data, or content of the object. The storage system can have one or more sensors for gathering, capturing or retrieving status data of the object. The sensor may comprise for instance a camera, a weighing machine or scales, a scanner such as a barcode or QR-scanner, or a scanner to scan the content of the object, such as e.g. an X-ray scanner or the like. The control unit may compare the status data gathered by the sensor to data stored in a database, in order to determine whether an object should be stored in the pouch storage and/or transferred via the first transfer station to the pouch system.

The control unit can further be configured to determine whether an object conveyed by a second load handling means of the pouch system or stored in the pouch storage is to be transferred, preferably with the second transfer station, to a first load handling means of the first sorter. For instance, the control unit may determine upon payment of outstanding duties or fees that the object is to be transferred from the pouch system via the second transfer station to the first sorter. Subsequently, the object can be discharged. In some embodiments, the control unit can alternatively or additionally determine that an object is to be unloaded from the pouch system, when the object is stored for longer than a specified time interval, e.g. longer than seven days. Unloading the object may comprise not transferring the object to the first sorter, but instead discharging the object via an unloading station of the pouch system from the pouch system.

The first sorter can have a feed station to feed objects to the first load handling means. The first sorter can have a discharge station for discharging objects from the first load handling means. In some embodiments, the discharge station can comprise or can be a chute. In some embodiments, all objects to be sorted are fed via the feed station to the first sorter, whereupon the control unit may determine for every object whether it is to be discharged by the discharge station or transferred via the first transfer station to the pouch system for storage.

The pouch system can have a loading station to load objects into the second load handling means. The pouch system can have an unloading station for unloading or discharging objects from the second load handling means. Via the unloading station, objects may be removed or discharged from the pouch system when they have been longer than a specified time interval, e.g. longer than seven days. Via the loading station, objects may be reintroduced into the pouch system. For instance, if an object has been unloaded via the unloading station, the same object can be fed back to the pouch system again via the loading station.

The pouch storage can have at least one dynamic buffer. In some embodiments, the pouch conveyor can be or can comprise the dynamic buffer. The dynamic buffer can have more than one buffer loop. The pouch storage, in particular the dynamic buffer, can be configured to discharge a specific pouch stored in the pouch storage, such that a specific pouch stored in the pouch storage (and the object contained therein) may be retrieved. The buffer loops and/or track switches of the pouch storage can be arranged accordingly. In some embodiments, the pouch storage has a maximum input, output and/or throughput of 1500 pouches/hour. In some embodiments, the pouch storage, or the dynamic buffer, respectively, does not sort or sequence the pouches and/or does not have a matrix sorter. In some other embodiments, the pouch storage, or the dynamic buffer, respectively, is configured to sort or sequence the pouches. In some embodiments, a matrix sorter can be provided.

Unlike the lying sorter, the capacity of the pouch system, such as e.g. the capacity for accommodating, buffering and/or storing pouches, can be expanded almost at will, even vertically. As a result, the storage requires a much reduced foot print in some embodiments, so that floor space becomes available for additional or other machinery, sorters, or functional units of the sorting system.

The pouch system can have a pouch buffer. The pouch buffer can provide empty pouches to be filled with objects to be transferred from the first sorter, i.e. the lying sorter. In some embodiments, the pouch buffer can provide storage for pouches (containing objects) to be stored, in addition to the pouch storage.

In or at the first transfer station, the first sorter and the pouch system can be arranged such that an object discharged by a first load handling means is directly transferable to a second load handling means. In some embodiments the object can fall into or onto the second load handling means, e.g. can fall into a pouch. When the first load handling means comprises a cross-sorter, the object can e.g. be conveyed such that it may fall from the cross-sorter into or onto the second load handling means, e.g. a pouch. When the first load handling means comprises a tilt-tray, the tray may be tilted such that the object may fall from the tilted tray into or onto the second load handling means, e.g. pouch. The first load handling means, for example a cross-belt or a tilt-tray, may be controlled such that the object is discharged such that it may fall into or onto the second load transfer means.

Additionally or alternatively, the first transfer station can have a first transfer point, onto which an object conveyed by a first load handling means can be dischargeable by the first load handling means, such that the object can be transferable from the first transfer point into or onto a second load handling means. In some embodiments, the object can be transferred from the first transfer point by one or more of a robot, a conveyor, a chute and/or a worker.

In or at the second transfer station, the first sorter and the pouch system can be arranged such that an object discharged by a second load handling means is directly transferable to a first load handling means. In some embodiments the object can fall into or onto the first load handling means. In some embodiments, the object can fall into or onto a cross-belt or a tilt-tray. When the second load handling means comprises a pouch, the pouch may be opened such that the object may fall from the pouch into or onto the first load handling means. The second transfer station can be configured to open the pouch accordingly.

Additionally or alternatively, the second transfer station can have a second transfer point, onto which an object conveyed by a second load handling means can be dischargeable by the second load handling means, such that the object can be transferable from the second transfer point into or onto a first load handling means. In some embodiments, the object can be transferred from the second transfer point by one or more of a robot, a conveyor, a chute and/or a worker.

The first transfer station can be configured to automatically transfer objects. The second transfer station can be configured to automatically transfer objects. For instance, the robot can be a picking robot, an articulated robot. However in some embodiments, the objects are to be transferred manually.

The first transfer station can have a detector which can be configured to identify, check and/or track an object transferred in, at or by the first transfer station. The second transfer station can have a detector which can be configured to identify, check and/or track an object transferred in, at or by the second transfer station. The detector can comprise a camera, a sensor or a reader. The detector can be configured to detect an identifier of the object.

Another aspect of the invention relates to a method for sorting objects, particularly parcels or mail items, the method comprising the steps:
feeding an object to a first sorter of a sorter system;
determining whether the object is an object to be buffered;
when the object is determined to be not an object to be buffered, discharging the object at an end point of the first sorter; and
when the object is determined to be an object to be buffered, the method comprising the steps:
   transferring the object from the first sorter to a pouch system of the sorter system;
   buffering the object in the pouch system;
   either transferring the object from the pouch system to the first sorter and discharging the object at the end point of the first sorter, or unloading the object from the pouch system;
wherein the first sorter is or comprises a lying sorter, and the pouch system comprises or is a pouch conveyor having pouches for conveying or holding the object.

When transferring the object from the first sorter to the pouch system, the object may be transferred with a first transfer station of the sorter system. When transferring the object from the pouch system to the first sorter, the object may be transferred with a second transfer station of the sorter system. When unloading the object from the pouch system, the object may be unloaded with an unloading station of the pouch system.

The method can be carried out by a sorter system as described above. A sorter system as described above can be configured to carry out the method.

The end point may be located at a discharge station. A discharge station may comprise the end point.

Buffering the object in the pouch system can comprise storing the object in a pouch storage or a pouch buffer.

Determining whether the object is an object to be buffered can comprise checking status data of the object. In some embodiments, the status data can comprise at least one of, or a combination of, delivery date, delivery destination, sender of the object, addressee of the object, identity and/or address of sender and/or addressee, customs data, or content such as content of the object, package parcel and the like.

Buffering the object in the pouch system can comprise buffering the object for a specified time interval and/or until a condition is fulfilled. Checking whether the condition is fulfilled can comprise checking status data of the object. The status data can comprise at least one of delivery date, delivery destination, sender of the object, addressee of the object, customs data, or package content. In some embodiments, the condition can pertain to (or equal) one or multiple of a payment of duties and/or fees, a request for delivery, e.g. by a sender and/or addressee, a clearance by an official, a delivery date, a country of origin, customs data, content of the object (e.g. content of parcel or package), or the like. The specified time interval can be seven days.

The object can be transferred to the first sorter, when the condition is fulfilled. In some embodiments, the object can be unloaded, when the specified time interval is elapsed and the condition is not fulfilled.

A second object can be loaded into the pouch system with a loading station of the pouch system. After loading the second object into the pouch system, the second object can either be buffered in the pouch system or be transferred to the first sorter with the second transfer station.

Transferring the object from the first sorter to the pouch system can comprise directly transferring the object from a first load handling means of the first sorter into or onto a second load handling means of the pouch system by dropping it into the second load handling means. Alternatively or additionally, transferring the object from the first sorter to the pouch system can comprise discharging the object at a transfer point of the first transfer station from a first load handling means of the first sorter, and transferring the object by a robot, conveyor, chute and/or worker to a second load handling means of the pouch system.

Transferring the object from the pouch system to the first sorter can comprise directly transferring the object from a second load handling means of the pouch system into or onto a first load handling means of the first sorter by dropping it into the second load handling means. Alternatively or additionally, transferring the object from the pouch system to the first sorter can comprise discharging the object at a transfer point of the second transfer station from a second load handling means of the pouch system, and transferring the object by a robot, conveyor, chute and/or worker to a first load handling means of the first sorter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The invention is further described and disclosed in view of the following figures:

FIG. 1: a schematic view of a sorter system according to an exemplary embodiment of the invention;

FIG. 2: a schematic view of an exemplary sorter system according to a second exemplary embodiment of the invention;

FIG. 3: a schematic view of an exemplary sorter system according to another exemplary embodiment of the invention;

FIG. 4: a schematic view of a pouch system according to an exemplary embodiment of the invention;

FIG. 5: a schematic view of an embodiment of a first transfer station;

FIG. 6: schematic views of embodiments of a first transfer station;

FIG. 7: another schematic views of an embodiment of a first transfer station;

FIG. 8: a schematic view of an embodiment of a second transfer station;

FIG. 9: schematic views of embodiments of a second transfer station; and

FIG. 10: another schematic views of an embodiment of a second transfer station.

### DETAILED DESCRIPTION

Example embodiments will now be described more fully with reference to the accompanying drawings.

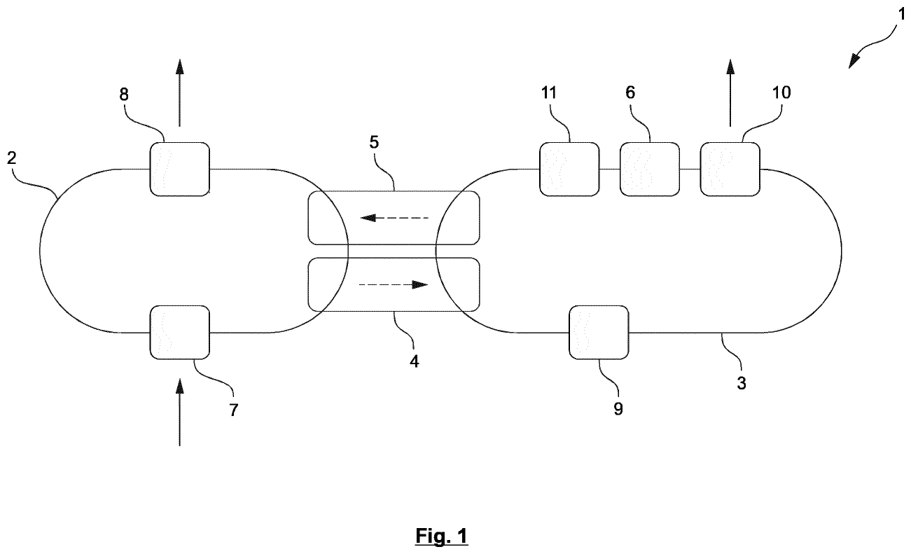

FIG. 1 shows a schematic view of an exemplary embodiment of a sorter system 1 according to the invention. The sorter system 1 has a first sorter 2 and a pouch system 3. The sorter system 1 has a first transfer station 4, via which objects 14 can be transferred from the first sorter 2 to the pouch system 3 (as indicated by the dashed arrow in FIG. 1). In particular, objects 14 held by first load handling means 12 of the first sorter 2 can be transferred to second load handling means 13 of the pouch system 3 with the first transfer station 4. The sorter system 1 can have a second transfer station 5, via which objects 14 can be transferred from the pouch system 3 to the first sorter 2 (as indicated by the dashed arrow in FIG. 1). In particular, objects 14 held by second load handling means 13 of the pouch system 3 can be transferred to first load handling means 12 of the fist sorter 2 with the second transfer station 5.

The first sorter 2 is or comprises a lying sorter. The lying sorter may be a closed loop sorter or a line sorter. The lying sorter may be comprise a cross-belt sorter or a tilt-tray sorter. The first load handling means 12 of the first sorter 2 can e.g. be or comprise carriages having one or more cross-belts, and/or one or more tilt-trays. The pouch system 3 is or comprises a pouch conveyor. The second load handling means 13 of the pouch system 3 can be or comprise pouches. The first load handling means 12 and/or the second load handling means 13 can be configured to hold or contain objects 14, e.g. mail items, parcels, packages, shipments, or the like. The first sorter 2 can transport or convey objects 14 with its first load handling means 12. The pouch system 3 can transport or convey objects 14 with its second load handling means 13. The respective load handling means can be configured to receive and/or discharge objects 14 transported with or held or accommodated therein.

The pouch system 3 has a pouch storage 6. The pouch storage 6 is configured to store pouches, such as pouches containing objects 14 to be stored. The pouch storage 6 can have at least one dynamic buffer. The dynamic buffer can have more than one buffer loop. The pouch storage 6, in particular the dynamic buffer, can be configured to discharge a specific pouch stored in the pouch storage 6, such that a specific pouch stored in the pouch storage 6 (and the object contained therein) may be retrieved. The buffer loops, drives and/or track switches of the pouch storage 6 can be arranged accordingly. In some embodiments, the pouch storage 6 has a maximum input, output and/or throughput of 1500 pouches/hour. In some embodiments, the pouch conveyor can be or comprise the dynamic buffer. In some embodiments, the dynamic buffer may be part of the pouch conveyor. In some embodiments, buffering or storing a pouch may comprise conveying the pouch along or with the pouch conveyor and/or pouch system, e.g. along one or multiple loops. In some embodiments, buffering or storing a pouch may comprise conveying the pouch past the second transfer station 5, without transferring the object.

The first sorter 2 can have a feed station 7, with which objects 14 such as parcels, mail items, shipments, packages, or the like, can be fed to the first sorter 2. The feed station 7 can be configured to feed or load an object (as indicated by the arrow of FIG. 1) into a first load handling means 12 of the first sorter 2. The first sorter 2 can have a discharge station 8, with which objects 14 conveyed or transported by, or held in or with, the first load handling means 12 can be discharged or removed from the first sorter 2. The discharge station 8 can comprise a chute. The discharge station 8 can be configured to discharge or unload an object (as indicated by the arrow of FIG. 1) from a first load handling means 12 of the first sorter 2.

The sorter system 1 can comprise a control unit. The control unit can be configured to determine for one, several or each object fed to or conveyed with the first sorter 2 whether the object is to be discharged or transferred to the pouch system 3. If the object is to be discharged, the object can be transported by a first load handling means 12 of the first sorter 2 to a discharge station 8 and discharged. If the object is to be transferred to the pouch system 3, the object can be transported by a first load handling means 12 of the first sorter 2 to the first transfer station 4 and transferred to the pouch system 3 and/or a second load handling means 13 of the pouch system 3. The pouch system 3 can subsequently store the object (and/or the second load handling means 13 holding or accommodating the object) in the pouch storage 6.

The control unit can be configured to determine whether an object (and/or a pouch holding or accommodating an object) stored in the pouch storage is to be retrieved and discharged. If so, the pouch holding the object can be transported to the second transfer station 5, where the object can be transferred to the first sorter 2 and/or a first load handling means 12 of the first sorter 2. Then, the object can be transported to a discharge station 8 and discharged from the first sorter 8.

In some embodiments, an object can be stored in the pouch storage until a condition is fulfilled. The condition can comprise e.g. payment of duties or fees, request for delivery by a sender and/or an addressee, clearance of the object by officials such as police or duty officials, or the like. Alternatively or additionally, the object may be stored in the pouch storage until a specified time interval has elapsed, e.g. until the object has been stored for a specified amount of time, e.g. seven days.

The control unit can be configured to determine whether the object is to be stored in, and/or is to be retrieved from, the pouch storage, or whether the object is to be transferred from the first sorter 2 to the pouch system 3 or vice versa, based on status data of the object. The status data may comprise at least one of, or a combination of, delivery date, delivery destination, sender of the object, e.g. address or identity, addressee of the object, e.g. address or identity, customs data, or package content. The sorter system 1 can have at least one sensor for obtaining the status data. For instance, the sorter system 1 can have a camera, a scanner or a weighing scale. The control unit can compare the status data of the object obtained from the sensor to data in a database.

As an example, the control unit can check whether duties have to be paid for a specific parcel (as e.g. indicated or identified by the identity and/or address of the sender and/or addressee, a tracking number, a QR-Code, barcode or the like), and if so, whether the duty has been paid. If duty is due but not paid, the control unit may determine that the object needs to be stored in the pouch system 3 and or the pouch storage 6, and/or needs to be transferred to the pouch system 3. When the duty has been paid, the object may be clear to be delivered. When the duty has been paid, the control unit may determine that the respective object (as identified as e.g. outlined above) may be discharged from the pouch storage 6, and/or transferred to the first sorter 2, such that the object may be discharged from the first sorter 2, e.g. via a discharge station 8, to be delivered to the addressee.

In another example, the control unit may determine that the content of the object, e.g. the content of a parcel, needs to be examined or opened by authorities such as e.g. customs officials or police. In that case, the object may be stored in the pouch storage until the time of examination, and subsequently discharged at a specific discharge station 8 of the first sorter 2 and/or unloaded via an unloading station 10 of the pouch system 3.

In some other exemplary embodiments, an addressee may request that an object (such as a e.g. a parcel or the like) to be sent to him may be held in the sorter system 1 (or the respective distribution centre having the sorter system 1) for a specified amount of time, e.g. the addressee may request a delivery at a later date. When determining whether the object is to be stored, the control unit can then check the database to take said request into account, and determine whether the object is to be stored. In some embodiments, the control unit may additionally determine how long the object is to be stored. Similarly, the control unit may determine to retrieve or discharge the stored object from the pouch storage for delivery, e.g. when the determined amount of storage time is elapsed or when there is a corresponding request by the addressee.

The examples given above are non-exhaustive, and/or may be combined.

In some embodiments, the control unit may check whether the pouch storage is full when determining whether to store the object. If the storage is full, the control unit may determine not to store the object in the pouch storage, and/or discharge the object via a specific discharge station 8 for further processing or storage in another storage. In some embodiments, the specific discharge station 8 is only used for said purpose or in the event that the storage is full, and not for regular discharging of objects 14.

In some embodiments, the pouch system 3 has an unloading station 10 for unloading or discharging objects 14 from the pouch system 3. In some embodiments, an object stored in the pouch storage 6 is unloaded via the unloading station 10, when it has been stored for longer than a specified amount of time, e.g. longer than a week. Thereby, objects 14 stored longer than the specified time interval are removed from the storage system 1, and/or the pouch system 3 and/or the pouch storage 6. For instance, in case duties and/or possible fees are not paid, the corresponding object, e.g. parcel, is removed from storage such that storage space may be freed up. The unloaded object may then be further processed, e.g. stored in another storage, returned to the sender or destroyed.

The pouch system 3 can have a loading station 9. The loading station 9 can be configured such that an object may be fed or loaded into a second load handling means 13 (pouch) of the pouch system 3. Then, the object can e.g. be stored in the pouch storage 6 or transferred to the second transfer station 5 and/or unloading station 9.

The pouch system 3 can have a pouch buffer 11. The pouch buffer 11 can store empty pouches. The empty pouches can be loaded or filled with the object at the first transfer station 4. In some embodiments, additionally or alternatively, the pouch buffer 11 can store filled pouches, thereby extending the pouch storage 6.

The layout of the sorter system 1, first sorter 2 and/or pouch system 3 can be different from the one shown in FIG. 1. For example, the first sorter 2 can have one or multiple feed stations 7 and/or discharge stations 8. The one or multiple feed stations 7 and/or discharge stations 8 can be arranged differently. The pouch system 3 can have one or multiple pouch storages 6, loading stations 9, unloading station 10 and/or pouch buffer 11. The one or multiple pouch storages 6, loading stations 9, unloading station 1 and/or pouch buffer 11 can be arranged differently. In some embodiments, the sorter system 1 can have one or multiple first transfer stations 4 and/or second transfer stations 5, one or multiple of which can be arranged differently.

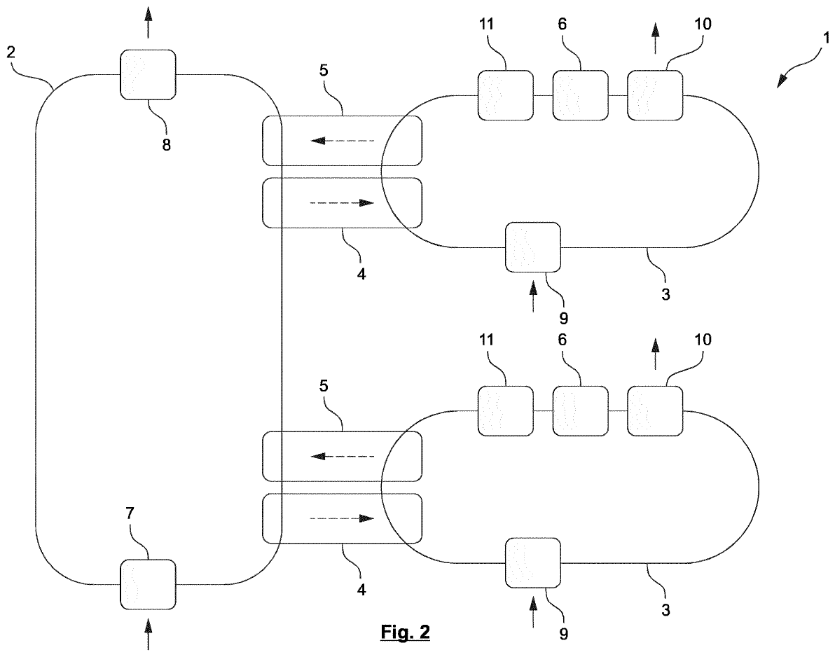

A second embodiment of a sorter system 1 is shown in FIG. 2. The embodiment shown in FIG. 2 can have one, more than one or all features and advantages of the embodiment shown in FIG. 1 and described above.

The sorter system 1 can have a second sorter, e.g. a pouch sorter. Alternatively or additionally, the sorter system 1 can have second pouch system 3, which can be arranged in parallel to the pouch system 3, cf. e.g. FIG. 2. In some embodiments, the control unit can determine whether to not store (e.g. to discharge) an object fed to the first sorter 2, or whether to store the object in the first pouch system or the second pouch system. The determination can be based on additional criteria. For instance, the first pouch system can be configured to store object for which duty has not been paid, and the second pouch system can be configured to store objects 14 for which the addressee requested a later delivery. In some embodiments, the sorter system 1 can have more than two pouch systems and/or sorters. In some embodiments, the criteria may comprise a e.g. delivery date. For instance, a first pouch system may store objects, for which a delayed delivery with a first delivery date has been requested. The second pouch system may store objects, for which a delayed delivery with a second delivery date has been requested. The second delivery date may be earlier or later than the first delivery date. First and second delivery date may differ by one or more days. In some embodiments, the criteria may comprise one or more of delivery date, delivery destination, sender of the object (14), addressee of the object (14), identity and/or address of sender and/or addressee, customs data, or content, and/or paid duty.

In some embodiments, at least two pouch systems are not arranged in parallel with respect to the first sorter (as sketched in FIG. 2), but being connected via one or more respective transfer stations to each other. In other word, there may be at least one pouch system, which is connected only via at least one other pouch system to the first sorter, or the lying sorter, respectively.

The sorter system 1 can have a first pouch system and a second pouch system, wherein the sorter system 1 can be configured to transfer objects 14 having a feature and/or fulfilling a criteria to the first pouch sorter, and the sorter system can be configured to transfer objects having a different feature and/or fulfilling a different criteria to the second pouch sorter. The feature and/or different feature can comprises one or more of delivery date, delivery destination, sender of the object, addressee of the object, identity and/or address of sender and/or addressee, customs data, or content. Fulfilling the criteria and/or fulfilling the different criteria can comprise the object matching one or more of delivery date, delivery destination, sender of the object, addressee of the object, identity and/or address of sender and/or addressee, customs data, or content. The sorter system can be configured to check and/or determine whether an object has a feature of fulfills a criteria and can then transfer the object accordingly. For instance, an object may have a feature “delivery date” which can be in date-format such as e.g. “yyyy-mm-dd” or the like. If e.g. the date-format matches a determined or specific date-format, the object may fulfil the criteria or have the feature. Two objects having different features may comprise them having the same kind of feature or criteria, but different values of said feature or criteria. For instance, a first object may have the feature “duty paid” with value “false” and a second object may have the feature “duty paid” with value “true”, such that the first object may fulfill the criteria whereas the second may not (or vice versa). In that example, the criteria may be “duty paid”. Of course, these are just examples, and other features or criteria may be checked, combined or chosen. If the sorter system 1 has more than two pouch systems 3, the objects may be transferred or distributed to the more than two pouch systems accordingly.

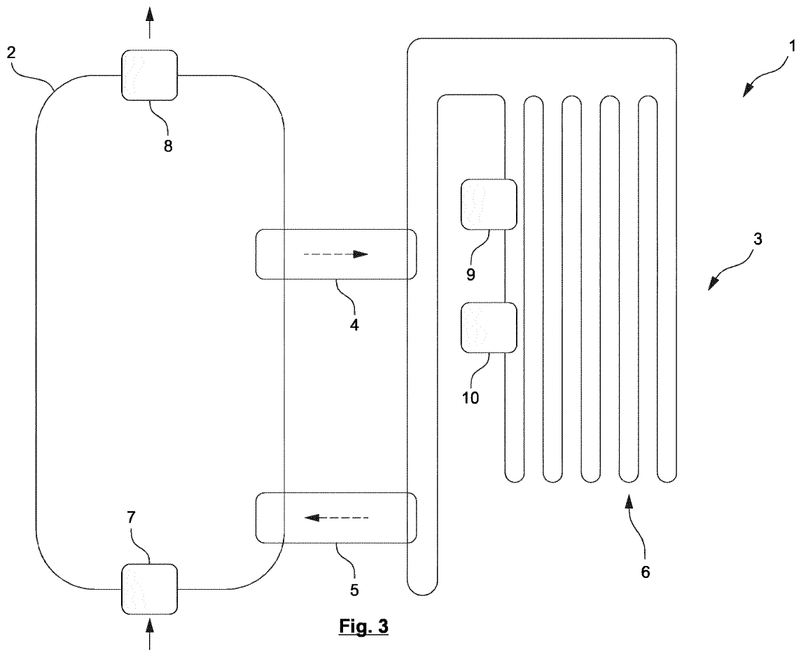

Another exemplary embodiment of a sorter system 1 is shown in FIG. 3. The embodiment shown in FIG. 3 can have one, more than one or all features and advantages of the embodiment shown in FIGS. 1 and 2 and described above. Particularly, the first sorter 1 can have two feeding stations 7 and four discharge stations 8. Particularly, the pouch system 3 can have a pouch storage 6, two loading station 9, two unloading station 10 and one pouch buffer 11. Particularly, the sorter system 1 can have one first transfer station 4 and one second transfer station 5.

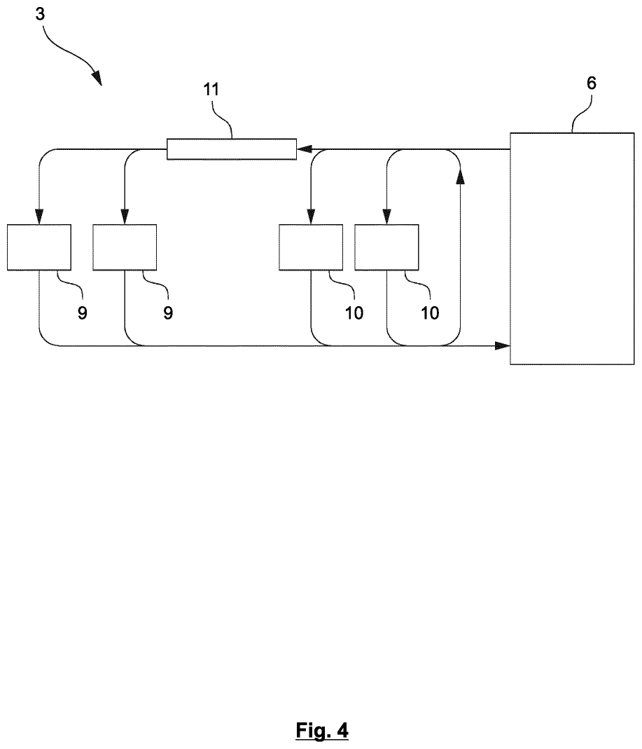

An exemplary layout of a pouch system 3 is shown in FIG. 4. The pouch system 3 shown in FIG. 4 can have one, more than one or all features and advantages of the pouch system 3 shown in FIGS. 1, 2 and 3 and described above. As shown, the pouch system 3 can have a pouch storage 6, two loading station 9, two unloading station 10 and one pouch buffer 11. The loading stations 9 may be arranged in parallel. The unloading stations 10 may be arranged in parallel. The pouch buffer 11 may be connected to the loading stations 9, unloading stations 10 and the pouch storage 6. The pouch storage 6 may be connected to the loading stations 9, unloading stations 10 and the pouch buffer 11. The pouch system 3 can have track switches, loops, buffer loops, and drives for driving the second load handling means 13 (pouches).

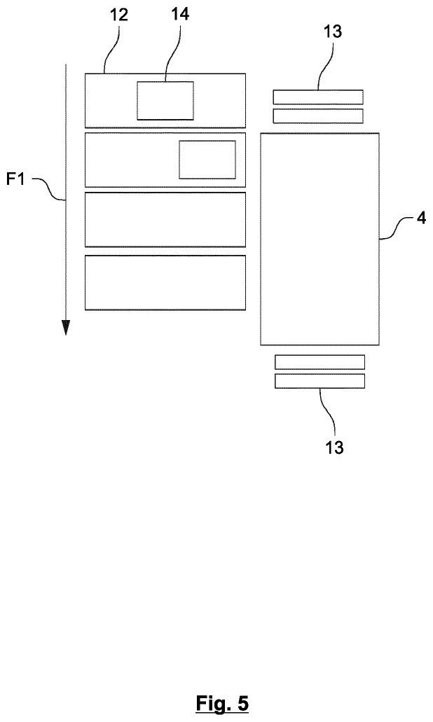

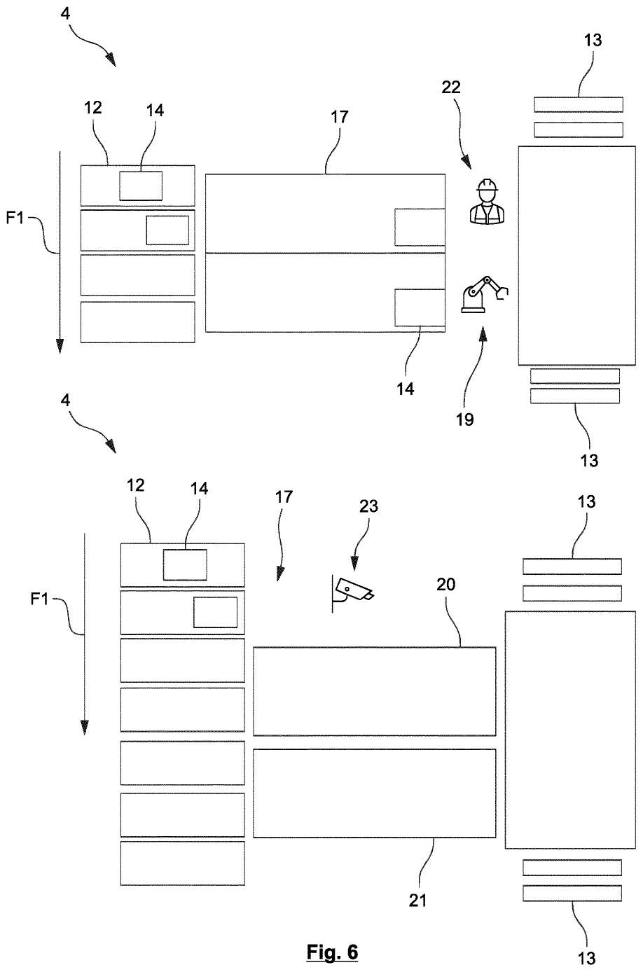

FIGS. 5 to 7 show exemplary embodiments of first transfer stations 4. As seen e.g. in FIG. 5, objects 14 can be transported (e.g. in a transport direction F1) by first load handling means 12 of the first sorter 2 to the first transfer station 4, where the objects 14 can be transferred to the pouch system 3.

In some embodiments, the first transfer station can have a first transfer point 17. At the first transfer point 17, the first load handling means 12 of the first sorter 2 can discharge one or more objects 14, which are to be transferred to the pouch system 3. Objects 14 not to be transferred to the pouch system 3 may not be discharged by the first load handling means 12. In some embodiments, the discharged object 14 can then be transferred into or onto a second load handling means 13. For instance, discharged object 14 can be transferred by a robot 19, e.g. a picker robot, an articulated robot or the like. Additionally or alternatively, the discharged object 14 can be transferred by a worker 22. In some embodiments, the discharged object 14 can be transferred additionally or alternatively by a conveyor 20 and/or a chute 21. In some embodiments, first load handling means 12 can be configured to discharge an object 14 onto conveyor 20 and/or chute 21.

The first transfer station 4 can have one or more detectors 23. One or more detectors 23 can be arranged at or near the first transfer point 17. Detector 23 can be configured to identify, determine, check and/or scan an identifier of the object 14. The identifier can be an alphanumeric code, a QR-code, A bar-code, and/or comprise of be stored on an RFID-Chip, or the like. The identifier may be an unique identifier identifying the object 14, its content or status data. In some embodiments, the identifier of an object 14 is detected or scanned by detector 23 to determine whether the object 14 is to be transferred to the pouch system 3. The identifier can be detected or scanned before the object 14 is discharged from the first load handling means 12. Alternatively or additionally, the identifier of an object 14 can be detected or scanned by detector 23 to control the transfer to the second load handling means 13. In some embodiments, controlling the transfer to the second load handling means 13 may comprise adjusting one or more of speed of conveyor 20, speed and/or position of first load handling means 12 and/or second load handling means 13, timing or control of the robot 19, communicating information to the worker 22 (such as e.g. information regarding transfer of the object 14) and/or opening of pouch 15, or the like.

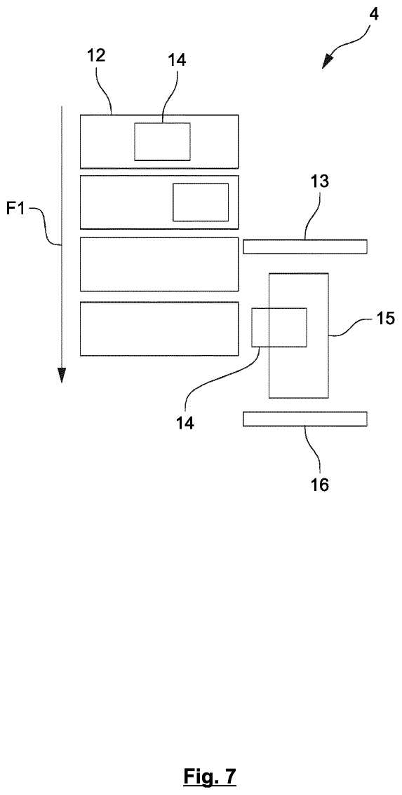

In some embodiments, first sorter 2 and pouch system 3 may be arranged such that in or at the first transfer station 4, the object 14 may be dropped from the first load handling means 12 into or unto the second load handling means 13, as seen e.g. in FIG. 7. First load handling means 12 and second load handling means 13 can be synchronized such that the object 14 can fall into or onto the second load handling means 13. When the second load handling means 13 comprises a pouch, the pouch 15 may be opened such that the object 14 can fall into pouch 15. When the object 14 is in pouch 15, pouch 15 can be closed, and the closed pouch 16 can then be conveyed, e.g. into pouch storage 6. The first transport station 4 can be configured to open and close pouch 15, 16. When the first load handling means 12 comprises a cross-belt, the cross-belt can be controlled and/or driven such that the object 14 can drop into or onto the second load handling means 13 and/or pouch 15. When the first load handling means 12 comprises a tilt-tray, the tilt-tray can be controlled and/or tilted such that the object 14 can drop into or onto the second load handling means 13 and/or pouch 15.

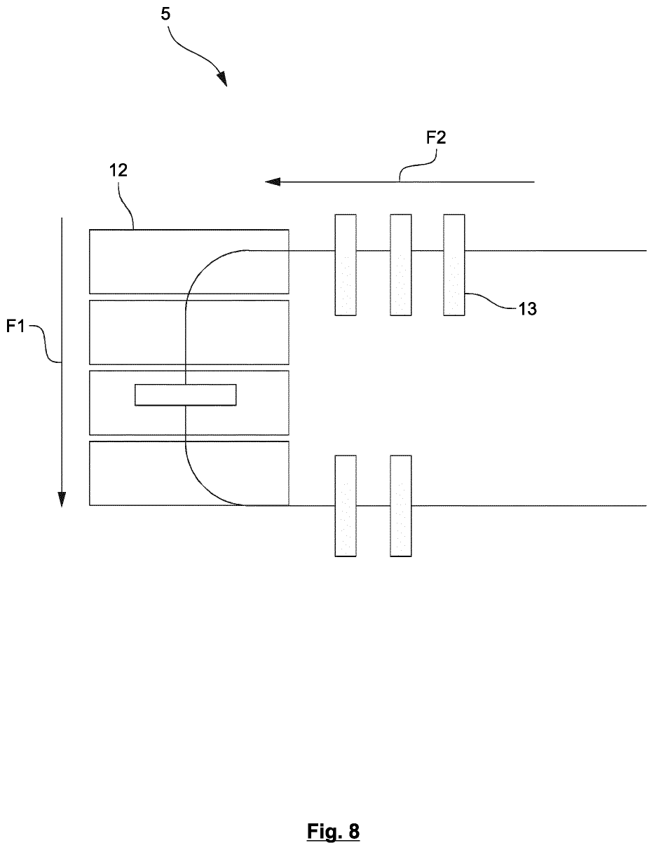

FIGS. 8 to 10 show exemplary embodiments of a second transport station 5. In some embodiments, first sorter 2 and pouch system 3 may be arranged such that in or at the second transfer station 5, the object 14 may be dropped from the second load handling means 13 into or unto the first load handling means 12, as seen e.g. in FIG. 8. First load handling means 12 and second load handling means 13 can be synchronized such that the object 14 can fall into or onto the first load handling means 12. When the second load handling means 13 comprises a pouch, the pouch may be opened such that the object 14 can fall or drop from the pouch. For instance, pouches 13 containing objects 14 to be transferred can be conveyed in transport direction F2 towards the first sorter 2 and/or first load handling means 12, as e.g. seen in FIG. 8. When the pouch 13 is located above a first load handling means 12, in some embodiments a specified or pre-determined load handling means 12, the pouch 13 can be opened. The empty pouch can then be conveyed away from the first sorter 2 and/or first load handling means 12. The second transport station 5 can be configured to open and close pouch 13. When the first load handling means 12 comprises a cross-belt, the second load handling means 13 and/or cross-belt can be controlled and/or driven such that the object 14 can drop into or onto the cross-belt. When the first load handling means 12 comprises a tilt-tray, the second load handling means 13 and/or tilt-tray can be controlled and/or driven such that the object 14 can drop into or onto the tilt-tray.

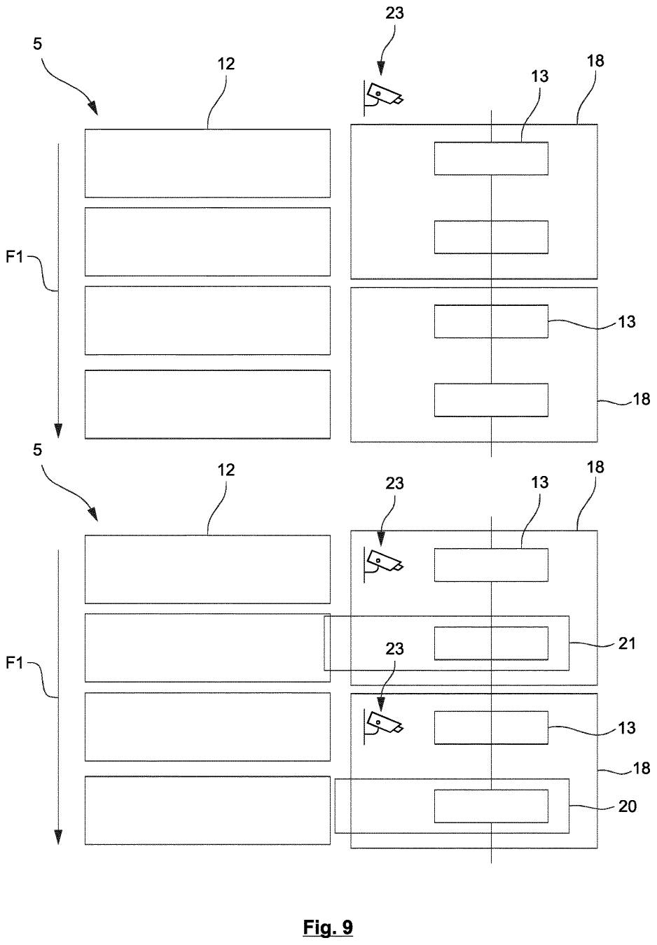

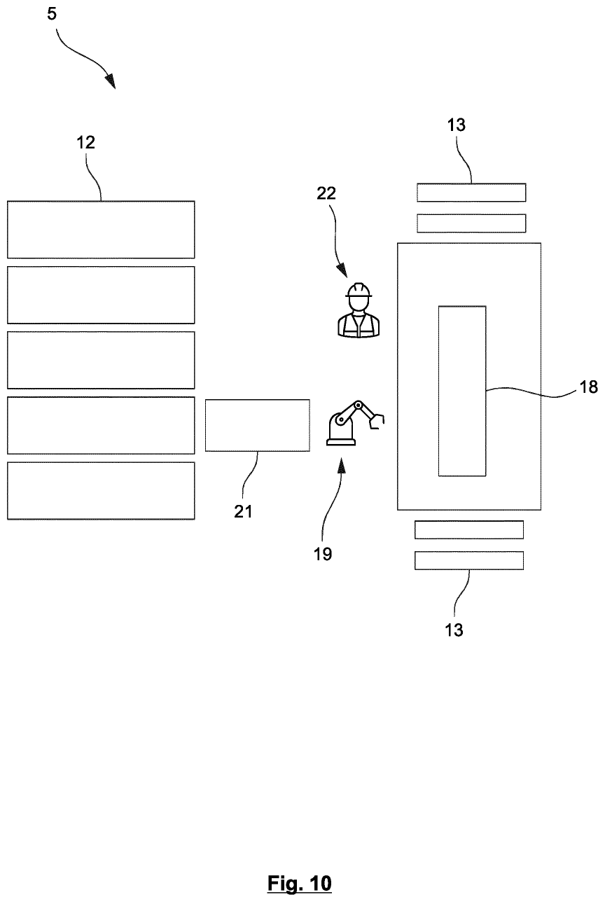

In some embodiments, the second transfer station 5 can have a second transfer point 18. At the second transfer point 18, the second load handling means 13 of the pouch system 3 can discharge one or more objects 14, which are to be transferred to the first sorter 2. Objects 14 not to be transferred to the first sorter 2 may not be discharged by the second load handling means 13. In some embodiments, the discharged object 14 can then be transferred into or onto a first load handling means 12. For instance, discharged object 14 can be transferred by a robot 19, e.g. a picker robot, an articulated robot or the like, as shown e.g. in FIG. 10. Additionally or alternatively, the discharged object 14 can be transferred by a worker 22. In some embodiments, the discharged object 14 can be transferred additionally or alternatively by a conveyor 20 and/or a chute 21, as seen e.g. in FIG. 9. In some embodiments, second load handling means 13 can be configured to discharge an object 14 onto conveyor 20 and/or chute 21.

The second transfer station 5 can have one or more detectors 23. One or more detectors 23 can be arranged at or near the second transfer point 18. Detector 23 can be configured to identify, determine, check and/or scan an identifier of the object 14. The identifier can be an alphanumeric code, a QR-code, A bar-code, and/or comprise of be stored on an RFID-Chip, or the like. The identifier may be an unique identifier identifying the object 14, its content or status data. In some embodiments, the identifier of an object 14 is detected or scanned by detector 23 to determine whether the object 14 is to be transferred to the first sorter 2. The identifier can be detected or scanned before the object 14 is discharged from the second load handling means 13. Alternatively or additionally, the identifier of an object 14 can be detected or scanned by detector 23 to control the transfer to the first load handling means 12. In some embodiments, controlling the transfer to the first load handling means 12 may comprise adjusting one or more of speed of conveyor 20, speed and/or position of first load handling means 12 and/or second load handling means 13, timing or control of the robot 19, communicating information to the worker 22 (such as e.g. information regarding transfer of the object 14) and/or opening of pouch 15, or the like. As shown e.g. in FIG. 10, the object 14 can be transferred to e.g. a conveyor 20 (and/or a chute 20, not shown in FIG. 10), e.g. by robot 19 or worker 22, before being transferred to the first load handling means 12.

The embodiments as shown in the figures are only exemplary. A first transfer station 4 can have one or more of first transfer point 17, robot 19, conveyor 20, chute 21, worker 22, camera 23, and/or any combination thereof. A second transfer station 5 can have one or more of second transfer point 18, robot 19, conveyor 20, chute 21, worker 22, camera 23, and/or any combination thereof.

The features as disclosed in the claims, description and figures may be essential for the realization of the invention, individually as well as in combination.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-19. (canceled)

20. A sorter system for sorting objects, the sorter system comprising a first sorter with a multiplicity of first load handling means for objects to be conveyed or sorted, the sorter system having a pouch system with a multiplicity of second load handling means for objects to be conveyed and/or stored or buffered, the sorter system having a first transfer station which is configured to transfer objects from the first load handling means of the first sorter to the second load handling means of the pouch system, wherein the first sorter is or comprises a lying sorter, preferably a cross-belt sorter or a tilt-tray sorter, and the second load handling means being or comprising pouches, wherein the pouch system is or comprises a pouch conveyor, wherein the pouch system has a pouch storage for storing pouches, such that objects held by pouches are storable in the pouch storage.

21. The sorter system of claim 20, the sorter system comprising a second sorter, preferably a pouch sorter, and/or second pouch system.

22. The sorter system of claim 20, the sorter system having at least one second pouch system, the sorter system being configured to transfer objects having a feature and/or fulfilling a criteria to the pouch system, and the sorter system being configured to transfer objects having a different feature and/or fulfilling a different criteria to the second pouch system, wherein preferably the feature comprises one or more of delivery date, delivery destination, sender of the object, addressee of the object, identity and/or address of sender and/or addressee, customs data, or content and/or preferably fulfilling a criteria comprises the object matching one or more of delivery date, delivery destination, sender of the object, addressee of the object, identity and/or address of sender and/or addressee, customs data, or content.

23. The sorter system of claim 20, the sorter system having a second transfer station which is configured to transfer objects from the second load handling means of the pouch system to the first load handling means of the first sorter.

24. The sorter system of claim 20, wherein the sorter system has a control unit which is configured to determine whether an object conveyed by a first load handling means of the first sorter is to be transferred, with the first transfer station, to a second load handling means of the pouch system or to be discharged from the first sorter.

25. The sorter system of claim 24, wherein the control unit is further configured to determine whether an object conveyed by a second load handling means of the pouch system or stored in the pouch storage is to be transferred, preferably with the second transfer station, to a first load handling means of the first sorter.

26. The sorter system of claim 20, wherein the pouch system has a loading station to load objects into the second load handling means, and/or wherein the pouch system has an unloading station for unloading or discharging objects from the second load handling means.

27. The sorter system of claim 20, wherein the pouch storage has at least one dynamic buffer, wherein preferably the dynamic buffer has more than one buffer loop.

28. The sorter system of claim 20, wherein
in or at the first transfer station, the first sorter and the pouch system are arranged such that an object discharged by a first load handling means is directly transferable to a second load handling means, preferably directly falling into a pouch; and/or
the first transfer station has a first transfer point, onto which an object conveyed by a first load handling means is dischargeable by the first load handling means, such that the object is transferable from the first transfer point into or onto a second load handling means by a robot, a conveyor, a chute and/or a worker.

29. The sorter system of claim 23, wherein
in or at the second transfer station, the first sorter and the pouch system are arranged such that an object discharged by a second load handling means is directly transferable to a first load handling means, preferably directly falling into or onto a tray or cross-belt; and/or
the second transfer station has a second transfer point, onto which an object conveyed by a second load handling means is dischargeable by the second load handling means, such that the object is transferable from the first transfer point into or onto a second load handling means by a robot, a conveyor, a chute and/or a worker.

30. The sorter system of claim 28, wherein the first transfer station and/or the second transfer station has a detector, preferably a camera, which is configured to identify, check and/or track an object transferred in, at or by the first transfer station and/or the second transfer station.

31. A method for sorting objects, particularly parcels or mail items, the method comprising:
feeding an object to a first sorter of a sorter system;
determining whether the object is an object to be buffered;
when the object is determined to be not an object to be buffered, discharging the object at an end point of the first sorter; and
when the object is determined to be an object to be buffered, the method comprising the steps:
transferring the object from the first sorter to a pouch system of the sorter system;
buffering the object in the pouch system;
either transferring the object from the pouch system to the first sorter and discharging the object at the end point of the first sorter, or unloading the object from the pouch system;
wherein the first sorter is or comprises a lying sorter, and the pouch system comprises or is a pouch conveyor having pouches for conveying or holding the object.

32. The method of claim 31, wherein buffering the object in the pouch system comprises storing the object in a pouch storage or a pouch buffer.

33. The method of claim 31, wherein determining whether the object is an object to be buffered comprises checking status data of the object, the status data preferably comprising at least one of delivery date, delivery destination, sender of the object, addressee of the object, customs data, or package content.

34. The method of claim 31, wherein buffering the object in the pouch system comprises buffering the object for a specified time interval and/or until a condition is fulfilled, wherein preferably checking whether the condition is fulfilled comprises checking status data of the object, the status data preferably comprising at least one of delivery date, delivery destination, sender of the object, addressee of the object, identity and/or address of sender and/or addressee, customs data, or content.

35. The method of claim 34, wherein the object is transferred to the first sorter, when the condition is fulfilled, and/or wherein the object is unloaded, when the specified time interval is elapsed and the condition is not fulfilled.

36. The method of claim 31, wherein a second object is loaded into the pouch system with a loading station of the pouch system, and, after loading the second object into the pouch system, the second object either being buffered in the pouch system or being transferred to the first sorter with a second transfer station.

37. The method of claim 31, wherein transferring the object from the first sorter to the pouch system comprises
directly transferring the object from a first load handling means of the first sorter into or onto a second load handling means of the pouch system by dropping it into the second load handling means; and/or
discharging the object at a transfer point of a first transfer station from a first load handling means of the first sorter, and transferring the object by a robot, conveyor, chute and/or worker to a second load handling means of the pouch system.

38. The method of claim 31, wherein transferring the object from the pouch system to the first sorter comprises
directly transferring the object from a second load handling means of the pouch system into or onto a first load handling means of the first sorter by dropping it into the second load handling means; and/or
discharging the object at a transfer point of a second transfer station from a second load handling means of the pouch system, and transferring the object by a robot, conveyor, chute and/or worker to a first load handling means of the first sorter.
